(19) United States
(12) Patent Application Publication
(10) Pub. No.: US 2024/0294333 A1
(43) Pub. Date: Sep. 5, 2024

(54) CLIMBING DEVICE FOR AN AUTOMATED ARTICLE STORAGE SYSTEM

(71) Applicant: FIVES XCELLA, Lamor-Plage (FR)

(72) Inventors: Julien REY, LORIENT (FR); Aurélien JAMES, LORIENT (FR); Lénaïck LOUIS REGIS, LE BIGNON (FR)

(21) Appl. No.: 18/565,366

(22) PCT Filed: May 31, 2022
(86) PCT No.: PCT/EP2022/064718

§ 371 Date: Nov. 29, 2023

(30) Foreign Application Priority Data
May 31, 2021 (FR) FR2105722

(51) Int. Cl. B65G 1/04; B65G 1/06; B65G 1/10

(52) U.S. Cl. CPC B65G 1/0492; B65G 1/065; B65G 1/10

(57) ABSTRACT

An automated article storage system includes automatically guided carriages having a first hooking system, and a rack including a plurality of storage levels and a vertically moving column, and the vertically moving column including a first movable lifting system configured to vertically move a first automatically guided carriage, and a second movable lifting system, adjacent to the first lifting system, configured to vertically move a second automatically guided carriage, independently of the movement of the first automatically guided carriage, the first lifting system and/or the second lifting system include a second hooking system configured to co-operate with the first hooking system such that the hooks are engaged for raising or lowering purposes.

### TECHNICAL FIELD OF THE INVENTION

The invention relates to the field of intralogistics and is aimed at an automated item storage system, for example a warehouse. In this system, items are transported by automatically guided transport carriages to specific storage positions to be deposited for a certain time length and then retrieved by the system for transport outside, for example for delivery to a customer.

### STATE OF THE ART

In this field, storage systems which use automatically guided carriages to move around the racking in order to place or pick up an item are known.

To allow vertical movement of the automatically guided carriages, it is known to provide pinions on opposite sides of the carriages, which mesh with toothed racks or chains fixed to opposite uprights of the racking. Once the carriage is positioned between the racks or chains, the motors of the carriage engage the pinions in the racks and rotate them, enabling the carriage to be raised or lowered from one storage level to another.

The drawback of this type of system is that each carriage has to be fitted with 4 motor-driven pinions, pinion drive means and pinion entry/exit means. As a result, the carriages are of complex construction. As such storage systems comprise a large number of carriages, the cost of the carriages can make the system too expensive.

In addition, drawbacks of these systems include meshing difficulties which can result from the fact that 4 pinions have to be aligned with racks/chains.

Another drawback is that racking often requires uprights connecting each storage compartment. Racking thus requires a large number of uprights and associated climbing means, which also increases racking costs.

Also known are storage systems with a simple lift with a mobile base in a shaft, pulled by cables for example, to stop at each storage level. The drawback of these systems is that it is necessary to multiply the number of lifts in the racking in order to achieve a correct carriage movement rate. This results in a loss of storage space and an increase in facility costs.

The purpose of the invention is therefore to provide an automated storage system that solves the problems of the solutions described above.

### SUMMARY OF THE INVENTION

To this end, the invention relates to an automated item storage system comprising:
a plurality of automatically guided carriages each capable of transporting an item, and
a racking comprising a plurality of superimposed storage levels each comprising an aisle in which automatically guided carriages can circulate and a vertical movement column connecting the storage levels and allowing movement of automatically guided carriages along this column between an item entry/exit level and one of the storage levels, or between two storage levels,

Said vertical movement column comprising:
first mobile lifting means configured to move a first automatically guided carriage vertically, and
second mobile lifting means adjacent to the first lifting means, configured to move a second automatically guided carriage vertically, independently of the movement of the first automatically guided carriage.

The first lifting means and the second lifting means each enable an automatically guided carriage to be moved vertically. As a result, a carriage does not need pinions and drive means, since the mobile lifting means of the column provide the movement. Accordingly, carriages are of simple construction and less expensive.

Even if first and second lifting means are mentioned, the column can obviously also have third lifting means, fourth lifting means, and so on.

Furthermore, as the vertical movement of the automatically guided carriages takes place within a limited zone forming the column, the racking is standard and does not require a large number of uprights fitted with climbing means. As a result, the racking is also of simple and inexpensive structure.

Besides, the fact that several carriages can be moved simultaneously in the same vertical movement column increases the rate of movement of the carriages and the system does not require a large number of zones reserved for vertical movement. Indeed, a column according to the invention can achieve the same rate of movement as several vertical movement shafts in solutions of the state of the art.

In this description, for the purposes of the invention, it is meant:
by “lifting means”, a plurality of lifting means, for example 2, 3 or 4 means. To facilitate the reader's understanding, the term “means” is sometimes replaced by “set of means”.
by “automatically guided carriage”, any vehicle (or shuttle, or robot or AGV) guided automatically on the ground, for example to move from one point to another in a warehouse, but also in the racking so that it can transport an object stored or to be stored. An automatically guided robot is commonly referred to as an AMR (Automated Mobile Robot).
by “column”, a limited zone reserved for the vertical movement of automatically guided carriages. For example, in some embodiments, the vertical movement column corresponds to a shaft connecting storage levels in the racking. In some examples of embodiments, the vertical movement column is arranged between two parallel portions of the racking.

In both of the above examples, the dimensions of the column may be close. The dimensions of the columns can, for example, be chosen so as to allow the passage of a single automatically guided carriage (or AMR) at a time. In this case, two successive automatically guided carriages, one mounted by the first means and the other mounted by the second means, can follow each other but cannot cross each other.

Advantageously, the first lifting means and second lifting means can be arranged in the column so that each first lifting means is adjacent to a respective second lifting means.

The arrangement of the first and second lifting means in the column by placing each first means adjacent to a respective second lifting means, enables the space required for vertically moving two successive automatically guided carriages to be reduced. Indeed, the arrangement of the first and second means in the column enables successive carriages to be moved one above the other and along very close vertical movement axes.

As a result, it becomes possible to arrange several means (that is, sets of means) in the same shaft to enable several carriages to be moved simultaneously while keeping the dimensions of the vertical movement column reduced.

According to embodiments:
an automatically guided carriage may comprise first, preferably lateral, hooking means; and
the first lifting means and/or the second lifting means may comprise second, preferably lateral, hooking means configured to cooperate with the first hooking means so as to perform hooking for lifting and then unhooking to release the carriage, for example in an aisle or on the ground.

By performing hooking of the automatically guided carriage (AMR) to the lifting means only for raising or lowering and then releasing the carriage to move in an aisle of a storage level or on the ground, the column becomes immediately available for moving a new carriage by the first means or the second means. Furthermore, the automatically guided carriages moved by the first vertical movement means do not block the movement of the carriages moved by the second vertical movement means and vice versa. For example, when the first means move a carriage to the second storage level, the latter is released to move in the aisle of this level and will not hinder the movement of another carriage by the second means to the upper levels. Accordingly, by performing hooking only for movement within the column, there is a high movement capacity without the carriages getting blocked, since each carriage moved up to a storage level releases the passage when it leaves the column. This also gives considerable flexibility in managing carriage movements within the column.

According to embodiments, the first hooking means belonging to the automatically guided carriages are retractable.

Advantageously, the second hooking means are arranged to receive the first hooking means when they are in an extended position.

Advantageously, the first lifting means may comprise a plurality of first means arranged laterally, at least two first means facing each other.

The second lifting means may comprise a plurality of second means arranged laterally, at least two second means facing each other.

By arranging the first and/or second lifting means laterally in the vertical movement column, the space between the first lifting means and/or the second lifting means is reserved for automatically guided carriages. A carriage arrives between the first and/or second lifting means activating the first hooking means so that they cooperate with the second hooking means to move the carriage vertically.

Advantageously, the space between the first and second sides of the vertical movement column is reserved exclusively for the movement of the automatically guided carriages. By reserving the space between the first side and the second side

Advantageously, the first lifting means and/or the second lifting means may comprise chains, cables or belts carrying the second hooking means.

These lifting means are robust and reliable in use. Belts have the added advantage of allowing rapid movement with reduced noise and requiring little maintenance. Chains have the advantage of making it easier to add hooking means.

According to embodiments, the second hooking means are integral with the belts, chains or cables. Advantageously, the first lifting means and/or the second lifting means comprise belts:
the first hooking means may comprise spindles, each being mobile between a backward position and a forward position,
the second hooking means may comprise hooking pieces integral with the belts and each arranged to receive a mobile spindle when the latter is in the forward position.

The advantage of such means is that they are simple, easy to implement and of small overall size. They also provide good stability for the carriage when moving within the column and consequently enable the carriage to move quickly without the risk of an accident.

In some embodiments, a first lifting means and/or a second lifting means may comprise:
an endless belt arranged between two pulleys, and
a plurality of second hooking means integral with the belt.

In this case, it is possible to move several successive carriages in the same direction (raising or lowering) with a same set of lifting means (for example the first means) and thus further increase the rate of movement of the carriages.

Optionally, the hooking means are spaced apart by a pitch corresponding to a multiple of a vertical distance between two storage levels.

In some embodiments, a first lifting means and/or a second lifting means may comprise two belt portions connected by a hooking piece comprising a housing.

This has the advantage of providing low-cost vertical movement means while maintaining good reliability. As the hooking piece is manufactured separately from the belt, it has good solidity and resistance to weight when raising and lowering carriages. Furthermore, as said piece does not pass over the pulleys, this type of lifting means has good resistance to wear, and therefore reduces operating costs.

Advantageously, the hooking piece can be arranged between two guide uprights along which it can slide when raising and lowering. This provides better stability during vertical movement of the carriage.

In some embodiments, the number of first lifting means and/or the number of second lifting means may be between 2 and 4. In other embodiments, the number may be greater than 4.

### BRIEF DESCRIPTION OF THE FIGURES

Other features and advantages of the invention will become apparent from the description below in relation to the appended drawings, given by way of non-limiting examples, in which:

FIG. 1 represents a first example of racking according to the invention;

FIG. 2 is a top view of a vertical movement column according to a first example of embodiment;

FIG. 3 shows a second example of racking according to the invention;

FIG. 4 shows a top view of a vertical movement column according to a second example of embodiment;

FIG. 5 shows a partial isometric view of a vertical movement column;

FIG. 6 shows a partial side view of the vertical movement column of FIG. 5;

FIG. 7 shows a zoom illustrating an example of hooking between a carriage and a lifting means;

FIG. 8 shows a zoom showing the hooking between a carriage and a lifting means according to an alternative embodiment.

In the remainder of the description, elements having an identical structure or similar functions will be referred to by the same references.

### DETAILED DESCRIPTION

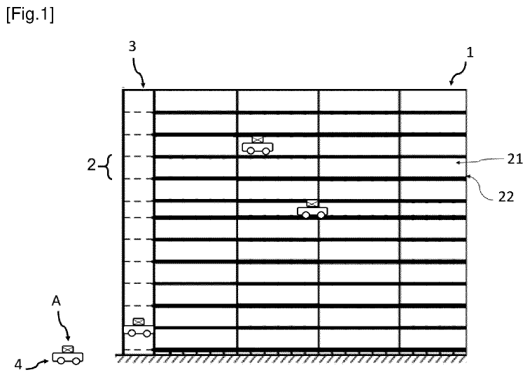

FIG. 1 schematically represents a first simplified example of a storage system according to the invention. The storage system in this example comprises a stock formed by a three-dimensional racking 1 and a plurality of automatically guided carriages 4.

The racking 1 comprises a plurality of storage levels 2, each storage level 2 may comprise locations for storing items, for example in the form of shelves 21. Each storage level 2 may comprise an aisle 22 in which a carriage 4 may circulate to unload or pick up an item A. In examples of embodiments not illustrated, a storage level 2 may comprise a plurality of aisles for the circulation of automatically guided carriages 4.

The racking 1 may further comprise one or more columns 3 (in the form of shafts) connecting the plurality of storage levels 2 and allowing the automatically guided carriage 4 to move from one level 2 to another, or between a storage level 2 and an entry/exit level. For example, in FIG. 1 the entry/exit level may be the lowest level (at ground level), but it may also be the highest level (the roof). In examples not illustrated, the lowest level may be an entry (or exit) and the highest level an exit (or entry).

The automatically guided carriages 4 according to the invention are of simplified construction: they are not provided with motor-driven means (for example, pinions) to enable them to move up the shaft 3 by themselves. To enable vertical movement of the carriages 4, the column 3 comprises motor-driven lifting means enabling a carriage 4 to be moved along the shaft.

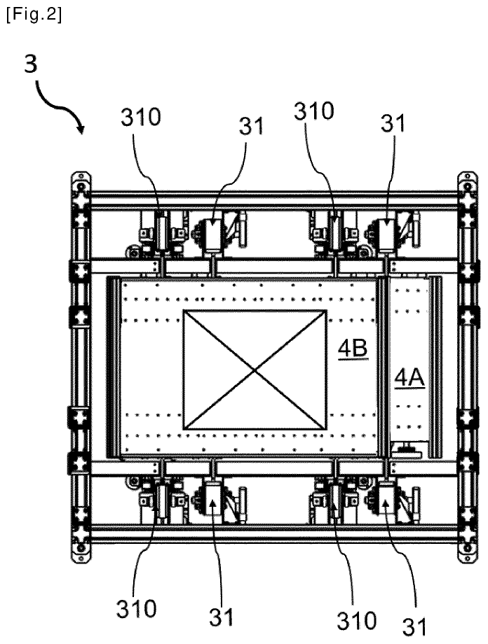

FIG. 2 illustrates a top view of an example of vertical movement column 3 in the form of a shaft. The column 3 can be associated with the example of embodiment in FIG. 1. In this example, the shaft 3 comprises a first set of lifting means 31, for example 4 endless belts. These first lifting means are configured to move a first carriage 4A vertically. The column 3 comprises a second set of lifting means 310, for example belts configured to make an alternating raising/lowering motion. The second means 310 are configured to move a second carriage 4B vertically in the same column.

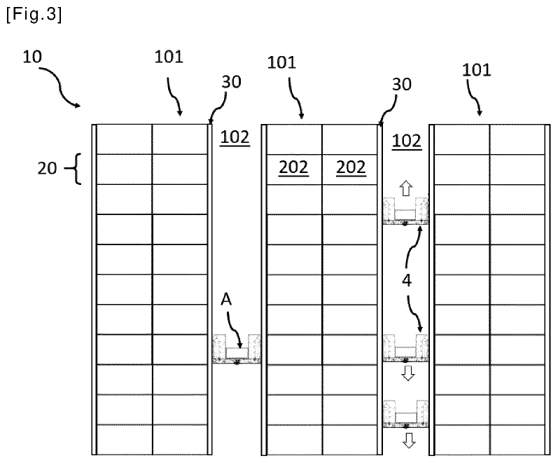

FIG. 3 shows a front view of a storage system according to a second example of embodiment. In this example, the stock comprises an alternative racking 10 consisting of pairs of storage rows 101 separated by aisles 102. Automatically guided carriages 4 can circulate horizontally in the aisle 102 to unload items A to be stored in a shelf 202 of a storage level 20.

The carriage 4 can also pick up a stored item A to move it inside or outside the racking 10. For example, a carriage 4 may move an item A from one storage level 20 to another, or from a storage level 20 in which it is stored to remove it to the outside, for example, as part of a delivery to a customer who has placed an order. This also applies to the examples described above.

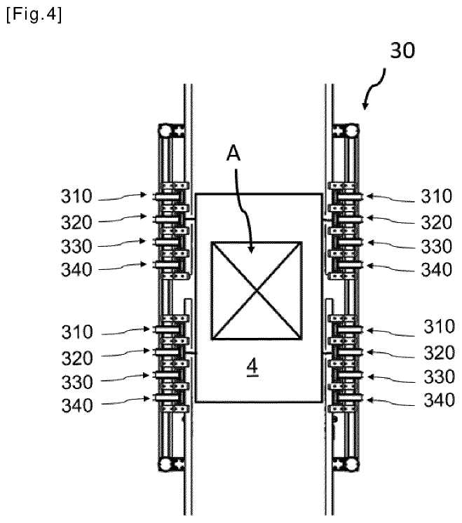

FIG. 4 shows an example vertical movement column 30 that can be used with the system of FIG. 3. In this example, first lifting means 310, second lifting means 320, third lifting means 330 and fourth lifting means 340, can transport respective automatically guided carriages 4 vertically. For the sake of simplicity, only one carriage 4 moved by the means 320 is illustrated. The four sets of vertical movement means 310 to 340 may each transport one or more automatically guided carriages at the same time, however, this is not mandatory.

According to this example of embodiment, each first means 310 is adjacent to a second means 320, a third means 330 and a fourth means 340.

In this example, each of the sets of first means 310, second means 320, third means 330 and fourth means 340, may comprise four belts.

In examples not illustrated, the column of FIG. 4 can also be used with the system according to FIG. 1.

In other examples not illustrated, the column of FIG. 2 may also be used with the system according to FIG. 3.

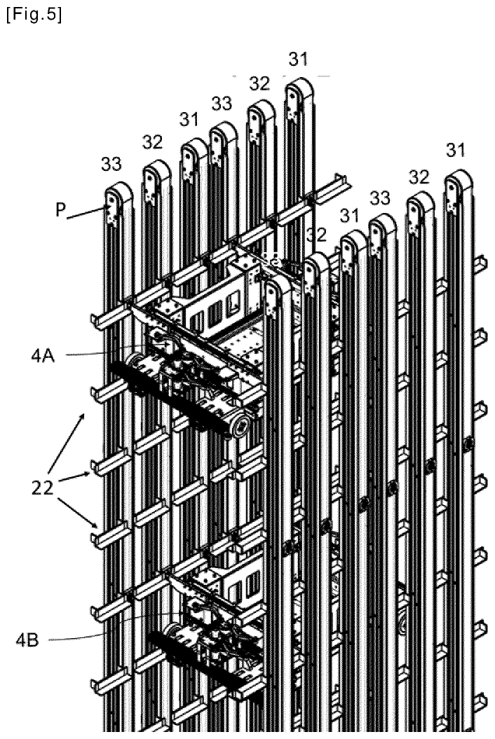

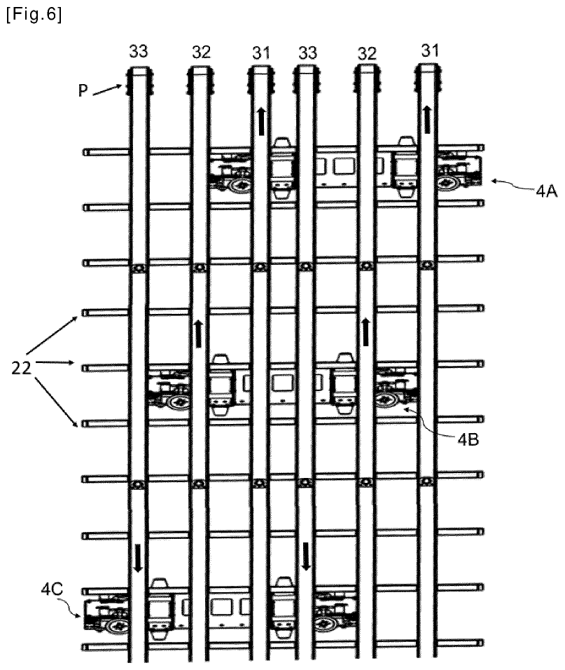

FIGS. 5 and 6 show schematic partial views of a vertical movement column, in an isometric view and a side view respectively. In this example, the column 3 comprises a set of first means 31, a set of second means 32 and a set of third means 33. Each set of means 31, 32, 33 comprises four means which may be endless belts gripped between an upper pulley P and a lower pulley (not shown). The belts 31 can move a first carriage 4A vertically, for example in a raising direction as shown in FIG. 6. The belts 32 and 33 can move a second carriage 4B and a third carriage 4C respectively.

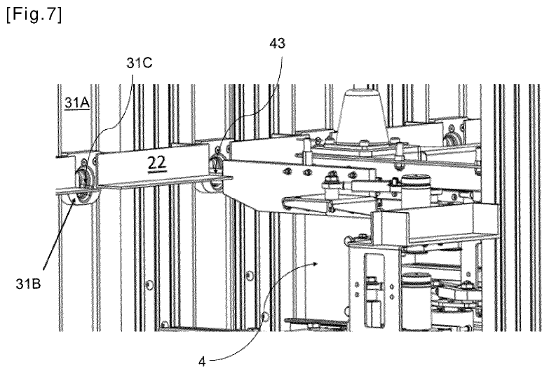

Each of the means in FIGS. 5 and 6 may comprise a belt 31A and a hooking piece 31B as shown in FIG. 7.

Advantageously, a belt can comprise a plurality of hooking means (31 B) integral with the belt (31A) and spaced apart by a pitch corresponding to a multiple of a vertical distance between two storage levels (2).

The hooking piece 31B may be integral with the belt 31A or incorporated into the same. In this example, the hooking piece comprises a housing 31C which can receive a means for hooking the carriage 4, which can be a spindle 43 mobile between a backward position, not shown, and a forward position as seen in FIG. 7.

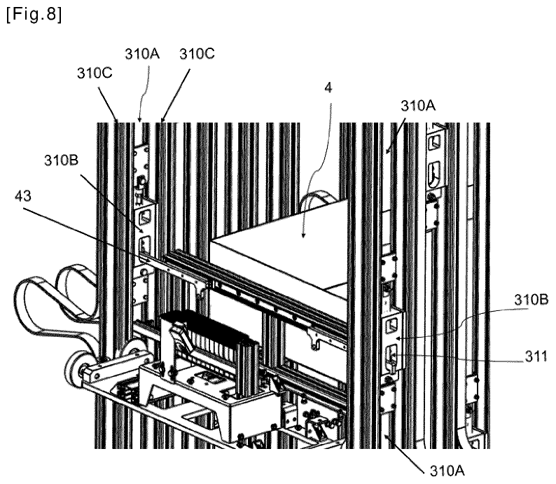

FIG. 8 shows an alternative in which the first lifting means 310 comprise two belt portions 310A connected by a hooking piece 310B.

Advantageously, in this example, the hooking piece 3108 is arranged between two guide uprights 310C along which it slides when raising and lowering.

Also in this example, the hooking piece comprises a housing 311 that can receive a means for hooking the carriage 4, in the form of a spindle 43 mobile between a backward position, not shown, and a forward position as seen in FIG. 8.

The hooking means set forth with reference to the drawings described above represent only non-limiting examples of the invention.

Different hooking means may be contemplated by the person skilled in the art without departing from the invention, whether on the side of the carriage or on the side of the lifting means.

For example, instead of mobile spindles, the hooking means of the carriage could be in the form of a clamp that clamps and hitches to a toothed belt.

Besides, the orientation of the belts may be different, for example rotated by 90° with respect to the examples shown in the figures.

1. An automated item storage system comprising:
a plurality of automatically guided carriages each capable of transporting an item, and
a racking comprising a plurality of superimposed storage levels each comprising an aisle in which the plurality of automatically guided carriages are configured to circulate and a vertical movement column connecting the plurality of superimposed storage levels and allowing movement of the plurality of automatically guided carriages along the vertical movement column between an entry/exit level of items and one of the plurality of superimposed storage levels, or between two of the plurality of superimposed storage levels,
said vertical movement column comprising:
first mobile lifting means configured to move a first automatically guided carriage vertically, and
second mobile lifting means adjacent to the first lifting means configured to move a second automatically guided carriage vertically independently of the movement of the first automatically guided carriage,
wherein an automatically guided carriage of the plurality of automatically guided carriages comprises first hooking means; and
the first lifting means and/or the second lifting means comprise second hooking means configured to cooperate with the first hooking means so as to perform hooking for lifting or lowering and then unhooking to release the automatically guided carriage.

2. The automated item storage system according to claim 1, wherein said first lifting means and second lifting means are arranged in the vertical movement column such that each first lifting means is adjacent to a respective second lifting means.

3. The automated item storage system according to claim 1, wherein the first lifting means and/or the second lifting means comprise chains, cables or belts carrying the second hooking means.

4. The automated item storage system according to claim 1, wherein the first lifting means and/or the second lifting means comprising belts:
the first hooking means comprise spindles each being mobile between a backward position and a forward position,
the second hooking means being integral with the belts or incorporated into the same, comprise housings each arranged to receive a mobile spindle when in the forward position.

5. The automated item storage system according to claim 4, wherein a first lifting means and/or a second lifting means comprise:
an endless belt arranged between two pulleys, and
a plurality of second hooking means integral with the belt.

6. The automated item storage system according to claim 4, wherein a first lifting means and/or a second lifting means comprises two belt portions connected by a hooking piece comprising a housing.

7. The automated item storage system according to claim 6, wherein said hooking piece is arranged between two guide uprights along which it slides when raising or lowering.

8. The automated item storage system according to claim 1, wherein the vertical movement column is arranged in a shaft connecting storage levels of the racking.

9. The automated item storage system according to claim 1, wherein the vertical movement column is arranged between two parallel portions of the racking.
